(19) United States
(12) Patent Application Publication
(10) Pub. No.: US 2025/0198710 A1
(43) Pub. Date: Jun. 19, 2025

(54) HEATING OR COOLING ELEMENT

(71) Applicant: Vidar Last Holding BV, Mastenbroek (NL)

(72) Inventor: Vidar Johan LAST, Mastenbroek (NL)

(21) Appl. No.: 18/843,156

(22) PCT Filed: Feb. 27, 2023
(86) PCT No.: PCT/EP2023/054784

§ 371 Date: Aug. 30, 2024

(30) Foreign Application Priority Data
Mar. 3, 2022 (EP) 22159959.0

(51) Int. Cl. F28F 9/00

(52) U.S. Cl. CPC F28F 9/001

(57) ABSTRACT

The invention pertains to a heating or cooling element comprising a first carrier mat, a second carrier mat, a first tube which is located in between the first and second carrier mat and kept in meander or spiral form to the first and second carrier mat, wherein the heating or cooling element can be rolled up; and wherein preferably the first and second 5 carrier mat is made of polymer material; the first carrier mat is connected to the second carrier mat to keep the first tube substantially in place.

The present invention relates to a heating or cooling element.

Heating or cooling elements are known in the art, in particular for underfloor heating. EP 3 205 945 and WO 2019/031962 disclose floor elements comprising tubes or conduits and a carrier mat, the carrier mat being rollable. The said carrier mat is generally a metal grid, which requires cutting to create the right shape. The production is limited to single meander or double meander patterns when automatically produced. Moreover, conventional prefabricated floor elements require additional tubes to be connected to the outer ends of the floor element, which also requires additional mechanical attachment to the floor to keep the tubes in place. The positioning of the fixtures requires additional time and is therefore less convenient.

The objective of the present invention is to provide a novel heating or cooling element.

The present invention pertains to a heating or cooling element comprising a first carrier mat, a second carrier mat, a first tube which is located in between the first and second carrier mat and kept in meander or spiral form to the first and second carrier mat, wherein the heating or cooling element can be rolled up; and the first carrier mat is connected to the second carrier mat to keep the first tube substantially in place.

In a preferred embodiment, the first and second carrier mats are made of polymer material. By using two carrier mats being of a polymer material, the carrier mats can be connected to each other on two sides next to the first tube so that the first tube is kept in place. A multitude of such connections along the first tube allows the positioning and immobilization of the first tube in the desired pattern between the two carrier mats. The invention also foresees to create such connections without making use of separate connection means such as tie rips or glue to fasten the first tube to the carrier mat. A further advantage of the heating or cooling element of the invention is that it can be rolled up for easy transport and storage, and it can be unrolled, e.g. on a building floor easily so that laying the inventive element becomes easy and less time consuming. The first and second carrier mat being of polymer material enables the inventive element to be laid out in a flat manner without parts sticking upward (out of plane). When the element is applied on the floor this has the additional benefit that the element does not have to be attached to the floor surface or that considerably less attachments to the floor surface need to be applied, which in turn leads to a shorter installation time and effort. The use of polymeric material in the carrier mats and consequently the inventive element is generally lighter than a metal carrier mat as is currently commercially used. In addition, the inventive element in particular through the first and second carrier mat provides for a strengthening of the surface, preferably a floor, in which it is applied, and moreover the element causes an improved pressure distribution over the surface and allows for a larger weight of objects placed on the surface, preferably a floor.

The heating or cooling element can be used for any suitable use to heat or cool its surroundings as known in the art. The inventive element can be applied in a floor, a wall or a ceiling, or a combination thereof. In one embodiment, the heating or cooling element of the invention is a floor element.

The element of the invention comprises a first and second carrier mat, which can be made from any material known in the art and suitable for use in carrier mats. Examples of such materials include metal like iron or steel and polymeric material. Preferably, the first and second carrier mats are made of a polymeric material. The polymeric material is preferably a thermoplastic polymer. Examples of thermoplastic polymers include polyethylene (PE), polypropylene (PP) and polyvinyl chloride (PVC). The polymeric material used in the first and second carrier mat may be the same or different, preferably the polymeric material in the first and second carrier mat is the same. It is also envisaged that the polymer used in the first and/or second carrier mat is at least partially a recycled polymer. It is contemplated that the polymeric material used in the wires of the carrier mats has a metal core, such as a steel core, which still allows connecting the first and second carrier mats through the polymeric shell. The carrier mat is preferably embodied as a mesh with a wire thickness of the polymeric material of 1 to 20 mm, preferably of 1 to 10 mm and most preferably from 1 to 5 mm. Because of the small wire thickness the carrier mat can be cut with a hand tool. At such a small wire thickness the weight of the carrier mat moreover remains limited. A relatively large floor part can hereby be manufactured and rolled up without the tube being damaged by the weight of the rolled-up package.

The mesh of the first and/or second carrier mat can be in any shape known in the art. Preferably, the mesh of the mats can be in the shape of a square or a hexagonal (like a honeycomb), preferably the mesh is square-shaped. In one embodiment, the mesh width of the carrier mat is between 5 and 20 cm, preferably 15 cm. With such a mesh width the weight of the carrier mat is further limited so that the tube is not damaged by the weight of the rolled-up package. Also the mesh width is chosen such as to allow the first and the second carrier mat to be connected to each other next on both sides of the first tube to as to enable immobilization of the first tube.

The first and/or second carrier mat can preferably be cut with a hand tool. In this way, the carrier mats can be shaped to the room it will be rolled out, so that an optimal heating or cooling pattern can be provided. Preferably, the first and second carrier mats are shaped identically. Each carrier mat preferably has a thickness such that the force which has to be exerted on the carrier mat in order to cut it is less than 500 N, preferably less than 300 N and more preferably less than 100 N. Use is for instance made for cutting purposes of side cutting pliers or centre cutting pliers. The carrier mat can preferably be cut using a non-electrical hand tool.

The first tube in the element of the invention can be any conventional tube used for cooling or heating. The first tube may be made from polymer material or polymer laminate. The polymer material and/or polymer laminate can be any polymer material and/or polymer laminate known in the art which can be suitably used in heating or cooling elements of the invention. The polymer can be polyethylene in particular cross-linked polyethylene such as PEX-A, PEX-B, PEX-C or PE-RT. The polymer laminate can comprise a polymer like polyethylene (PE) or polypropylene (PP) and an oxygen barrier which can be a second polymer such as ethylene vinyl alcohol (EVOH) or a metal such as copper or aluminum. In a preferred embodiment the oxygen barrier is a second polymer, in particular ethylene vinyl alcohol (EVOH). The polymer laminate can be polyethylene with an oxygen barrier coating, or a multilayer comprises layers of the polymer and the second polymer and/or metal. In one embodiment, the polymer laminate may comprise three or more layers of the polymer and the oxygen barrier. Preferably, the polymer laminate comprises three or five layers. More preferably, the polymer laminate comprises three layers. Examples of such a polymer laminates include PE-EVOH-PE, PP-EVOH-PP, PEX-EVOH-PEX. Preferably, the polymer laminate is selected from PE-EVOH-PE and PEX-EVOH-PEX. Most preferably, the polymer laminate is PEX-EVOH-PEX. It is also envisaged that the polymer used in the first tube is at least partially a recycled polymer.

The first tube has an oxygen permeability below 0.32 mg/m³ at 40° C. The oxygen permeability is determined according to DIN 4726. Alternatively or additionally, the first tube has an oxygen permeability below 3.60 mg/m³ at 80° C. The low oxygen permeability of the first tube enables prevention of oxidation of metal parts, in particular iron containing parts, surrounding the inventive element.

The first tube is positioned in between the first and second carrier mat and the first tube is immobilized by connecting the first and second carrier mat on two positions next to the first tube. In one embodiment, the first and second carrier mats have a multitude of connections on two positions next to the first tube. The connection between the two carrier mats can be created by any means known in the art. Examples of such means include tie rips, glue, hooks created from either one of the carrier mats and heating and pressing of the two carrier mats into each other.

In one embodiment, hooks are created from one of the carrier mats by cutting a wire and reshaping the cut part into a hook by heating and shaping the cut part. The hook created can be used to connect with the other mat by hooking the hook around a wire of the other carrier mat. The presence of the first tube in between the two carrier mats and the length of the hook determine the force exerted on the first tube to immobilize the first tube. An advantage of the hooks is that no foreign material is necessary to create the connection, and that the part of the hooks substantially perpendicular to the carrier mats may also prevent the first tube of moving. In one embodiment, the positions of the hooks can be chosen such that the perpendicular part of the hooks are alternatingly on one and the other side alongside the first tube.

In a preferred embodiment, the connection between the first and second carrier mats is created by fluidizing at least part of the first and second carrier mats, e.g. by heating, and pressing the fluidized parts of the first and second carrier mats onto each other, and subsequently cooling the pressed parts of the carrier mats to solidify the fluidized parts. By repeating this connection on a plurality of locations on the first and second carrier mats the first tube can be immobilized in the desired pattern. In a preferred embodiment, the polymer material of the carrier mat is a thermoplastic polymer, which can be fluidized, formed and pressed. In one embodiment, the connection can be created through separate fluidizing, pressing and cooling. In another embodiment, the connection can be created through simultaneous fluidizing and pressing, and subsequent cooling.

The first tube generally forms a pattern known in the art. Examples of such patterns are a spiral, a meander or a double meander. In one embodiment, the first tube forms a pattern selected from a meander or a double meander. Preferably, the first tube forms a double meander. It is contemplated that two or more of such patterns are present in the inventive element.

In one embodiment, the center-to-center distance between the first tube positioned parallel on the carrier mat is generally between 10 and 20 cm. The desired center-to-center distance will depend on the required heating or cooling output of the inventive element, which can easily be determined by the skilled person. When the inventive element is applied as a general floor element, the inventive element generally has a center-to-center distance of 15 cm. When the inventive element is applied as a floor element which is positioned close to a window or an exit, the inventive element generally has a center-to-center distance of 10 cm.

In one embodiment, the diameter of the first tube in the element of the invention is between 10 and 32 mm. Preferably, the diameter of the first tube is at least 12 mm, more preferably at least 14 mm and most preferably at least 15 mm, and preferably at most 30 mm, more preferably at most 25 mm and most preferably at most 20 mm. Most preferably, the diameter of the first tube is 16 mm. The wall thickness of the first tube is generally at most 3 mm. Preferably, the wall thickness of the first tube is at least 1 mm, more preferably at least 1.5 mm, and preferably at most 2.5 mm.

The cooling and heating element can be rolled up to form a roll. The inventive element with the (polymeric) first and second carrier mats and first tube generally has a flexibility to allow rolling up of the element. The rolled-up element according to the invention can be more easily stored and/or transported. Moreover, the rolled-up element further allows easier application which requires simply unrolling of the element. The invention therefore also pertains to a rolled-up heating or cooling element comprising a first and second carrier mat, a first tube which is connected in meander or spiral form to the carrier mat, wherein the heating or cooling element can be rolled up; and wherein the carrier mat is made of polymer material, and the first carrier mat is connected to the second carrier mat to keep the first tube substantially in place.

The element of the invention, in particular the first tube may have an even number of outer ends. Generally, a first outer end, the input, allows for introducing fluid into the inventive element, and a second outer end, the output, allows the fluid to exit the inventive element. In operation, the fluid, preferably water, enters the element through the input or the first outer end, flows through the channels according to the desired pattern to enable heat exchange with its surroundings, and exits the element through the output or the second outer end. The element may alternatively comprise four or more outer ends (always even number) when multiple patterns are present with a separate input and output (and separate tubes). When four or more outer ends are present a corresponding multitude of (first) tubes is present in the element. The outer ends are generally connected through a manifold with the heater or cooler unit, which enables the fluid to flow through the tubes of the inventive element.

In one embodiment, the inventive element is pressurized, preferably with air. Preferably, the outer ends are closed in order to maintain the pressure within the inventive element. In one embodiment, the inventive element is pressurized prior to rolling up the element.

The invention further pertains to a process for preparing an in-plane heating or cooling element comprising a first carrier mat, a second carrier mat, a first tube which is located in between the first and second carrier mat and kept in meander or spiral form to the first and second carrier mat, wherein the heating or cooling element can be rolled up; and wherein preferably the first and second carrier mat are made of polymer material; and the first carrier mat is connected to the second carrier mat to keep the first tube substantially in place comprising the steps of:
(a) heating the heating or cooling element to a temperature of at least 50° C.;
(b) pressing the heating or cooling element to obtain an in-plane element; and
(c) cooling the heating or cooling element to a temperature of at most 30° C.

In one embodiment, the inventive process for preparing an in-plane heating or cooling element comprising a first carrier mat, a second carrier mat, a first tube which is located in between the first and second carrier mat and kept in meander or spiral form to the first and second carrier mat, wherein the heating or cooling element can be rolled up; and wherein preferably the carrier mat is made of polymer material; and the first carrier mat is connected to the second carrier mat to keep the first tube substantially in place comprising the steps of:
(a) contacting the heating or cooling element to an area, preferably a bath, having a temperature of at least 50° C.;
(b) pressing the heating or cooling element to obtain an in-plane element; and
(c) contacting the heating or cooling element to an area, preferably a bath, having a temperature of at most 30° C.

The process of the invention enables the production of an in-plane heating or cooling element, in particular of prefabricated elements containing a first and second (polymeric) carrier mat and first tube such as the element according to the invention. With the wording “in-plane” is meant that the heating or cooling element is in a single plane without any parts curling up and away from the surface. This allows for a more time-efficient laying of the heating or cooling element. This process also allows the prefabricated element to be rolled up, optionally stored and transported, and unrolled while maintaining the in-plane shape.

In step (a) of the process of the invention, the heating or cooling element is heated to a temperature of at least 50° C. The heating can be performed by flowing a liquid such as water and/or glycol with a temperature of at least 50° C. through the first tube. Alternatively or additionally, the heating or cooling element is contacted to an area, preferably a bath, having a temperature of at least 50° C. The area is heated by any means known in the art. Examples of such heating includes infrared heating, radiation, heated air, steam, chemical softening and a bath. The temperature is chosen such that the temperature of the polymer in the first and second carrier mats and first tube is sufficiently high to soften the polymer so that it can be pressed and set to an in-plane surface. The temperature in the area, preferably in the bath, is not chosen so high, i.e. close to or above the glass transition temperature of the polymer or polymers in the first and second carrier mats and first tube, that the diameter of the channels in the first tube reduce considerably or even get blocked. Therefore, the area temperature, preferably the bath temperature, and/or the liquid temperature is generally at least 10° C. below the glass transition temperature of the polymer, in particular of the polymer with the lowest glass transition temperature when more polymers are present. The liquid temperature is preferably at least 55° C., and most preferably at least 60° C., and preferably at most 110° C., more preferably at most 100° C., even more preferably at most 90° C., and most preferably at most 80° C. In one embodiment, the area temperature is preferably at least 55° C., and most preferably at least 60° C., and preferably at most 110° C., more preferably at most 100° C., even more preferably at most 90° C., and most preferably at most 80° C. In one embodiment, the bath temperature is preferably at least 55° C., and most preferably at least 60° C., and preferably at most 110° C., more preferably at most 100° C., even more preferably at most 90° C., and most preferably at most 80° C. The fluid making up the bath can be any suitable fluid. Preferably, the fluid is water.

In step (b) of the inventive process, the heating or cooling element is pressed into a single surface to obtain an in-plane element. Step (b) can be performed using a press with rolls or a surface and a roll in between which the element can be placed. The press includes a unit to apply the desired pressure onto the roll(s). Step (b) can be performed following step (a) and/or simultaneous with step (a).

The heated element is subsequently cooled to a temperature of at most 30° C. The cooling can be performed by flowing a liquid such as water and/or glycol with a temperature of at most 30° C. through the first tube. In one embodiment, the heated element is subsequently cooled in step (c) in an area, preferably a bath, with a temperature of at most 30° C. In step (c) the temperature of the heating or cooling element is chosen such that the polymer in the first and second carrier mats and the first tube is hard and not pliable anymore. The liquid temperature is preferably at most 25° C., and most preferably at most 20° C., and preferably at least 0° C., more preferably at least 5° C., even more preferably at least 10° C., and most preferably at least 15° C. In one embodiment, the area temperature is preferably at most 25° C., and most preferably at most 20° C., and preferably at least 0° C., more preferably at least 5° C., even more preferably at least 10° C., and most preferably at least 15° C. In one embodiment, the bath temperature is preferably at most 25° C., and most preferably at most 20° C., and preferably at least 0° C., more preferably at least 5° C., even more preferably at least 10° C., and most preferably at least 15° C. The fluid making up the bath can be any suitable fluid. Preferably, the fluid is water.

In a further embodiment, the heating or cooling element comprises a first tube having an oxygen barrier made from aluminium. The process for preparing an in-plane heating or cooling element comprising a first tube having an oxygen barrier made from aluminium comprises the step of:
(a) optionally contacting the heating or cooling element to an area, preferably a bath, having a temperature of at least 50° C.;
(b) pressing the heating or cooling element to obtain an in-plane element; and
(c) optionally contacting the heating or cooling element to an area, preferably a bath, having a temperature of at most 30° C.

The advantage of using a first tube comprising aluminium as the oxygen barrier can be formed by only pressing the element to obtain an in-plane element. The optional heating step (a) and cooling step (c) serve to improve the memory of the inventive element to the in-plane configuration even after being rolled up as the polymer material will also be set to an in plane configuration.

In a further embodiment, the inventive process for preparing an in-plane heating or cooling element an in-plane heating or cooling element comprising a first carrier mat, a second carrier mat, a first tube which is located in between the first and second carrier mat and kept in meander or spiral form to the first and second carrier mat, wherein the heating or cooling element can be rolled up; and wherein preferably the carrier mat is made of polymer material; and the first carrier mat is connected to the second carrier mat to keep the first tube substantially in, comprising the steps of:
(a) contacting the heating or cooling element to an area, preferably a bath, having a temperature of at most 0° C.;
(b) pressing the heating or cooling element to obtain an in-plane element; and
(c) contacting the heating or cooling element to an area, preferably a bath, having a temperature of at least 0° C. and at most 30° C.

The process of the invention enables the production of an in-plane heating or cooling element, in particular of prefabricated elements containing a first and second (polymeric) carrier mat and first tube such as the element according to the invention. The idea is to cool the inventive element to a temperature whereby the element is stiffer and can be shaped to an in-plane configuration.

The invention further pertains to the use of the heating or cooling element according to the invention in buildings. The invention further pertains to the use of the heating or cooling element according to the invention in floors, walls or ceilings, preferably in floors. The invention further pertains to the use of the heating or cooling element according to the invention in outside roads or in driveways. The invention further pertains to the use of the heating or cooling element according to the invention in agriculture. The element of the invention can be used to apply to soil to heat the soil and its surrounding, e.g. when crop or fruit may be lost due to frost. The invention further pertains to the use of the heating or cooling element according to the invention in a sports field, such as a football field or hockey field.

The invention further pertains to a machine for producing a pre-fabricated heating or cooling element comprising a first and a second carrier mat and a first tube provided in a pattern in between the first and second carrier mats, comprising:
a supply line for supplying the first carrier mat, wherein the supply line is configured to transport the carrier mat in its longitudinal direction;
a first supply line for supplying a first tube;
at least four first guides for positioning the first tube in meander or spiral form relative to the first carrier mat;
a supply line for supplying the second carrier mat, wherein the supply line is configured to transport the carrier mat in its longitudinal direction and to apply the second carrier mat onto the first tube; and
a binding apparatus for connecting the first and a second carrier mat in a meander-shaped or spiral-shaped pattern and to immobilize the first tube in between the first and second carrier mats,

wherein the first guides form pairs which are separately moveable along the same line arranged perpendicular to the longitudinal direction, and the pairs are positioned along the longitudinal direction. With the machine of the invention, the heating or cooling element can be produced. The advantage of the inventive machine is that the width of the element can be large, for example at least 2 meters, or even 4 meters.

In one embodiment, the number of first guides is even and at least 6, preferably at least 8 and most preferably at least 10, and preferably at most 50, and more preferably at most 40, and most preferably at most 30. The number of first guides depends on the pattern and the pattern size that is to be created.

The binding apparatus can be any apparatus known in the art suitable for connecting the first and a second carrier mat. Such binding apparatus may further create hooks as indicated above. In one embodiment, the binding apparatus may be able to apply tie rips or provide glue to fasten the carrier mats to each other. In a preferred embodiment, the binding apparatus is capable of hooking the hooks from one carrier mat to the other carrier mat. In a further preferred embodiment, the binding apparatus is capable of heating, pressing and cooling two wires from the two carrier mats to connect the two wires to each other.

Further advantages, features and details of the invention are elucidated on the basis of exemplary embodiments thereof, wherein reference is made to the accompanying figures:

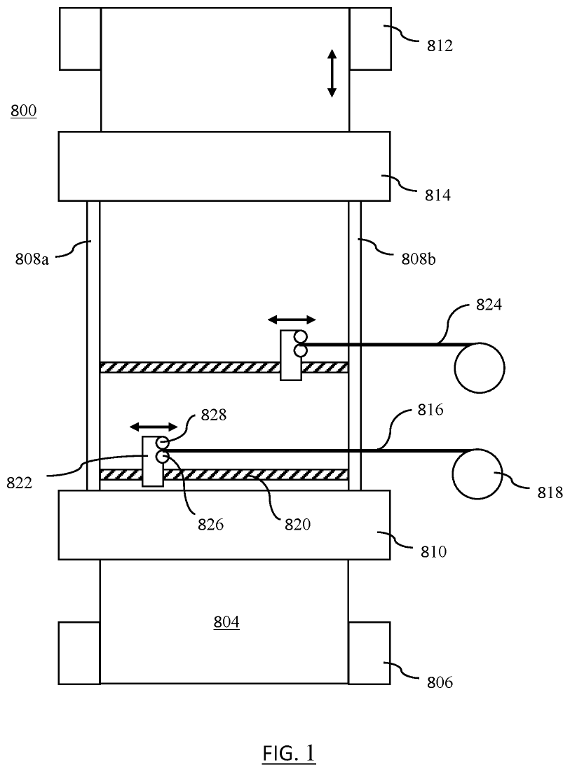

FIG. 1 shows a schematic overview of a device for manufacturing the heating or cooling element according to the invention;

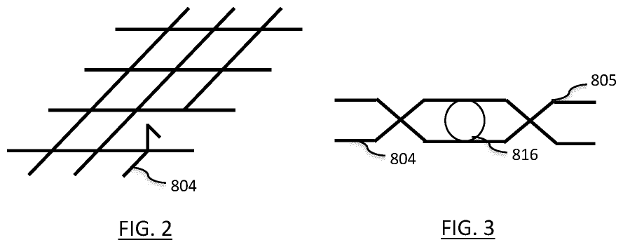

FIG. 2 shows the carrier mat with a hook created from the carrier mat according to the invention; and

FIG. 3 shows the first tube and the two carrier mats connected to each other around the first tube according to the invention.

Cooling and heating element of the invention comprises a first carrier mat 804 as mesh material to which first conduit or first tube 816 and second conduit or second tube 824 are to be secured at the connection location (not shown), which are created by cutting the polymer carrier mat 804 close to the tubes 816 or 824 at the connection location, and subsequently heating, bending and cooling the cut end so as to form a hook pointed in the direction of the conduits 816, 824. In the longitudinal direction (along the double arrow at the top right of FIG. 1) of first carrier mat 804 conduits 816, 824 are arranged at a chosen distance and in transverse direction of first mat 804 at a chosen distance in bends.

Free strip B is optionally provided at the side edges of carrier mat 4. Insulating mat 821 (not shown) is optionally arranged on the underside of first carrier mat 804.

Machine 800 (FIG. 1) comprises a roll 802 for the feed of a mesh-like first carrier mat 804.

For the sake of clarity in FIG. 1 the lattice of carrier mat 804 is not shown, although carrier mat 804 has in reality a mesh form.

Carrier mat 804 is guided from supply roll 806 to two conveyor belts 808a, 808b. A guide roller 810 is optionally provided to guide the carrier mat in the direction of conveyor belts 808a, 808b. Conveyor belts 808a, 808b are provided with studs so that the studs can hook into the meshes of the mesh-like carrier mat 804 in order to thus transport the mesh-like carrier mat 804. Carrier mat 804 is transported by conveyor belts 808a, 808b in the direction of the arrow P, after which carrier mat 804 is rolled up onto a roll 812. A guide roller 814 is optionally provided on this output side. Guide rollers 810, 814 contribute toward holding carrier mat 804 on the conveyor belt.

First conduit 816 is supplied from a roll 818. Arranged above the carrier mat is a rail 820 along which a carriage 822 can move reciprocally. The carriage is provided with one or more guide rollers 826, 828 which position conduit 816 on carrier mat 804. When the conduits 816, 824 have been applied to the first carrier mat 814, the conduits are kept in place by immobilization means 832 (not shown) in the desired pattern. A second carrier mat 805 is applied to the first carrier mat 804 with in between the conduits 816, 824.

Machine 800 moreover comprises a binding unit 823 (not shown), which provides connections to connect the first carrier mat 804 and the second carrier mat 805. The binding unit 823 may be a unit capable of cutting the wires of the carrier mat 804, heating the cut ends of the carrier mat to a temperature at which the polymer becomes flexible and bendable, bend the cut ends and cool the cut ends to create hooks (FIG. 2). In a preferred embodiment, the binding unit 823 is capable of heating the first and second carrier mat 804, 805 at the connection location, pressing the two fluidized wires onto each other and subsequently cooling the connected wire to obtain the connection (FIG. 3). The binding unit 823 can additionally or alternatively comprise means to glue or a connecting means to connect the two carrier mats 804, 805. The binding unit is for instance likewise provided on carriage 822. The binding unit can alternatively also be located on the other side of carrier mat 804 relative to the carriage for the purpose of attaching conduit 816 to mesh-like carrier mat 804 from this side.

Carriage 822 then moves in the opposite direction in order to place a new part of conduit 816 over the desired width on first carrier mat 804, wherein the connection means of the apparatus also attach this part of conduit 816 to carrier mat 804.

The optional second conduit 824 for the floor part/mat is arranged in similar manner on carrier mat 804. This second conduit 824 is particularly advantageous when a double meander pattern of the conduits 816 and 824 is to be created on the carrier mat 804. In machine 800 carrier mat 804 is transported horizontally along the attaching means. The attaching means, such as a binding unit, are in that case preferably provided on carriages 822 so that conduits 816, 824 can be attached immediately to carrier mat 804 while carriages 822 position conduits 816, 824 on carrier mat 804. It will be apparent that in machine 800 further process steps can also be included and/or be provided in other alternative manner.

Separate rails 821 (not shown) each with two guides 830 (not shown) are positioned parallel to rail 820. The guides 830 may each be provided with peripheral guides 831 (not shown) which serve to keep the conduits 816, 824 in place around the corresponding guide 830. The peripheral guide 831 may have a circular shape. The peripheral guide may be positioned towards the corresponding guide 830 to allow the conduit 816, 824 to move with the guide or to fasten the conduit 816, 824 between the peripheral guide 831 and guide 830, for example to tighten the pattern just before applying the cut end ties to connect the conduit 816, 824 to the carrier mat 804. These separate rails 821 with guide pairs 830 can be moved separately from the rail 820. In one embodiment the rails 821 can move vertically or be tilted. The number of rails will depend on the pattern that is to be formed. The guides 830 may be circular-shaped or have the shape of part of a circle, such as half of a circle. The guides are positioned parallel to the carrier mat 804 and capable of connecting with and shaping the tube 816 (or optional conduit 824), in particular providing the curve-like shape. The guides 830 may have indents in which the conduit 816 can be carried, and which maintains the conduits 816 (or optional conduit 824), in the same plane. The size of the guide 830 may be the same as the curve of the conduits 816, 824 require to produce the pattern. Alternatively, the size of guides 830 may be smaller than the curve of the conduits 816, 824. As a further alternative, the size of guides 830 may be larger than the curve of the conduits 816, 824, in particular when the distance between conduits 816, 824 is small, e.g. guides 830 with a diameter of 15 cm can be chosen when the heart-to-heart distance is 10 cm. Typically, the diameter of the guides 830 is between 5 and 15 cm. With the appropriate arrangement and number of guides 830 any desired pattern can be created including single meander shape, double meander shape and spiral shape.

In a preferred embodiment, the heating or cooling element, after the conduit pattern is applied and the carrier mats 804, 805 are connected and the first conduits 816, 824 is immobilized, is led through a water bath at a temperature of at least 50° C., pressed and cooled to room temperature to ensure that the inventive element is in plane and can be rolled up.

The present invention is by no means limited to the above-described embodiments thereof. The rights sought are defined by the following claims, within the scope of which many modifications can be envisaged.

1. A heating or cooling element comprising:
a first carrier mat;
a second carrier mat; and
a first tube located in between the first and second carrier mat and kept in meander or spiral form to the first and second carrier mat;
wherein the heating or cooling element is configured to be rolled up; and
wherein the first carrier mat is connected to the second carrier mat to keep the first tube substantially in place.

2. The heating or cooling element according to claim 1, wherein the first and second carrier mats are made of a polymer material.

3. The heating or cooling element according to claim 2, wherein the polymer material is a thermoplastic polymer.

4. The heating or cooling element according to claim 2, wherein the polymer material is selected from a group consisting of polyethylene, polypropylene and polyvinyl chloride.

5. The heating or cooling element according to claim 1, wherein the first and second carrier mats have a wired mesh shape.

6. The heating or cooling element according to claim 1, wherein each of the carrier mats comprise wires of a polymer material with a thickness between 1 and 20 mm.

7. The heating or cooling element according to claim 1, wherein the first and second carrier mats have a multitude of connections on two positions next to the first tube.

8. A machine comprising:
a first mat supply line for supplying a first carrier mat, wherein the first mat supply line is configured to transport the first carrier mat in a longitudinal direction of the first carrier mat;
a first supply line for supplying a first tube;
at least four first guides for positioning the first tube in a meander or spiral form relative to the first carrier mat;
a second mat supply line for supplying a second carrier mat, wherein the second mat supply line is configured to transport the second carrier mat in a longitudinal direction of the second carrier mat and to apply the second carrier mat onto the first tube; and
a binding apparatus for connecting the first and second carrier mats in a meander-shaped or spiral-shaped pattern and to immobilize the first tube in between the first and second carrier mats;
wherein the first guides form pairs which are separately moveable along the same line arranged perpendicular to the longitudinal direction of the carrier mats; and
wherein the pairs of first guides are positioned along the longitudinal direction.

9. The machine according to claim 8, wherein the number of first guides is even and at least 6 and at most 50.

10. The heating or cooling element according to claim 1, wherein each of the carrier mats comprise wires of a polymer material with a thickness between 1 and 5 mm.

11. A heating or cooling element comprising:
a first carrier mat having a wired mesh shape;
a second carrier mat having a wired mesh shape; and
a first tube located in between the first and second carrier mats and kept in a meander-shaped or spiral-shaped pattern relative to the first and second carrier mats;
wherein the first carrier mat is connected to the second carrier mat to maintain the first tube substantially in place;
wherein each of the carrier mats comprise wires of a polymer material with a thickness between 1 and 20 mm; and
wherein the heating or cooling element is configured to be rolled up.

12. The heating or cooling element according to claim 11, wherein each of the carrier mats have a thickness between 1 and 5 mm.

13. The heating or cooling element according to claim 11, wherein the polymer material is a thermoplastic polymer.

14. The heating or cooling element according to claim 11, wherein the polymer material is selected from a group consisting of polyethylene, polypropylene and polyvinyl chloride.

15. The heating or cooling element according to claim 11, wherein the first and second carrier mats have a multitude of connections on two positions next to the first tube.

16. A machine for producing the heating or cooling element of claim 11 comprising:
a first mat supply line for supplying the first carrier mat, wherein the first mat supply line is configured to transport the first carrier mat in a longitudinal direction of the first carrier mat;
a first supply line for supplying the first tube;
at least four first guides for positioning the first tube in the meander-shaped or spiral-shaped pattern;
a second mat supply line for supplying the second carrier mat, wherein the second mat supply line is configured to transport the second carrier mat in a longitudinal direction of the second carrier mat and to apply the second carrier mat onto the first tube; and
a binding apparatus for connecting the first and second carrier mats and to immobilize the first tube in between the first and second carrier mats;
wherein the longitudinal direction of the first carrier mat is the same as the longitudinal direction of the second carrier mat;
wherein the first guides form pairs that are separately moveable along the same line arranged perpendicular to the longitudinal direction of the carrier mats; and
wherein the pairs of first guides are positioned along the longitudinal direction.
